(19) United States
(12) Patent Application Publication
(10) Pub. No.: US 2013/0022240 A1
(43) Pub. Date: Jan. 24, 2013

(54) Remote Automated Planning and Tracking of Recorded Data

(71) Applicants: William C. Wolters, Forest, VA (US); Wayne D. Belden, Forest, VA (US)

(72) Inventors: William C. Wolters, Forest, VA (US); Wayne D. Belden, Forest, VA (US)

(21) Appl. No.: 13/552,705

(22) Filed: Jul. 19, 2012

Related U.S. Application Data
(60) Provisional application No. 61/509,476, filed on Jul. 19, 2011.

(51) Int. Cl. G06K 9/00

(52) U.S. Cl. 382/103

(57) ABSTRACT

The invention is a system for the remote automated planning and tracking of recorded data. The inventive system preferably is a software product that is used in conjunction with a foreign object tracking system and a visual inspection tracking system to provide an automated eddy current and visual inspection planning and tracking approach. The system provides a link between, for example, visual inspection of nuclear power plant steam generator secondary sides with eddy current inspection testing of the steam generator tubes from the primary side. This allows for possible loose part indications from the eddy current testing to be available to visual inspectors through foreign object tracking system for subsequent visual inspection and possible retrieval.

### CROSS-REFERENCE TO RELATED APPLICATIONS

This patent application claims the benefit of U.S. Provisional Patent Application No. 61/509,476 filed on Jul. 19, 2011, which is incorporated herein by reference in its entirety.

### BACKGROUND OF THE INVENTION

1. Field of the Invention

The present invention relates to a system and method for tracking items, and, more particularly, the present invention relates to a software product to provide an automated inspection planning and tracking approach.

2. Description of the Related Art

In many industries, especially those involving complex systems comprising sensitive and/or expensive equipment, it is beneficial to detect any foreign or undesired material that may have entered the system. The nuclear power industry is one such industry.

Foreign object tracking systems (“FOTS” or “FOT systems”) are currently in use in nuclear power plants. Currently FOTS processes involve manual entry into the database of an object identified by the secondary side inspection (“SSI”). Depending on the quantity of parts identified, the objects may not be entered in the database in a timely fashion thereby resulting in a delay to the disposition process of the part.

### SUMMARY OF THE INVENTION

The current invention addresses the deficiencies of conventional FOT systems by allowing the inspection team to automatically enter a part in the database using a point-click-add method direct from the inspection team's visual overlay system. In addition, action management for foreign object disposition currently requires manual review and tracking to completion of actions added. Furthermore, if further eddy current examinations are required for bounding or affected tubes where objects are identified, these examinations must be planned separately after manual identification of such need. Having a system in place that automatically plans required eddy current exams in addition to defining and managing actions for disposition utilizing knowledge and rule-based technologies will greatly expedite the foreign object process from identification through final disposition.

### DESCRIPTION OF THE DRAWINGS

The present invention is described with reference to the accompanying drawings, in which like reference characters reference like elements

FIG. 1 shows a screen shot of a steam generator visual inspection software control system.

FIG. 2 shows a screen shot of a foreign object tracking system.

FIG. 3 shows a schematic view of the remote automated planning and tracking of recorded data system of the present invention.

FIG. 4 shows a flowchart illustrating a general progression for the inventive foreign object identification action and disposition process.

### DETAILED DESCRIPTION OF THE INVENTION

The invention is a system for the remote automated planning and tracking of recorded data, and may be referred to herein by its acronym RAPTOR. The inventive system preferably is a software product that is used in conjunction with a FOTS and a visual inspection tracking system to provide an automated eddy current and visual inspection planning and tracking approach. A preferred system that the current invention may be used with is the AREVA FOT system, which provides a link between visual inspection of steam generator secondary sides with eddy current inspection testing (“ET”) of the steam generator tubes from the primary side. This allows for possible loose part indications (“PLPs”) from ET to be available to visual inspectors through FOTS for subsequent visual inspection and possible retrieval—otherwise known as foreign object search and retrieval (“FOSAR”). Known eddy current methods and equipment are described in U.S. Pat. Nos. 7,405,558, 5,025,215, and 4,441,078, which are incorporated herein by reference.

For visual inspection, AREVA also developed a visual inspection system that uses tube maps from ET to show location, annotation, and track position on the steam generator (“SG”) secondary side. This system is called VIEWS for visual inspection enhanced workflow system. FIG. 1 shows a screen shot of a steam generator visual inspection software control system.

With a fairly large number of PLPs or foreign objects, it becomes an iterative process for tracking and inspection (visual and eddy current). This can require an undesirably lengthy processing time, from both a utility and contractor point of view. Moreover, the process gets complicated if foreign objects are found but cannot be retrieved. In this case, engineering must evaluate the parts for plant impact or operability issues.

RAPTOR automates the identification of PUN and loose parts by allowing real time point and click from the VIEWs visual inspection system. This is accomplished behind the scenes, through software that extracts the data and stores it in FOTS, preferably in video or picture form. Disposition actions are automatically applied based on user-input knowledge parameters and site-approved guidelines, procedures, and disposition flowcharts. This reduces the time required for engineering evaluations, improves SSI inspection determinations, and improves the analysis and data management review processes.

PLP are identified through the normal course of ET inspection. Then the ET database is updated (a normal step in the ET procedure), FOTS uses such a PLP identification as a trigger to initiate rules to automatically update its database. Rules are defined to automatically add ET PLP information to its database based on indication code and location, as well as probe technique utilized in data acquisition. Once identified and stored in FOTS for tracking purposes, the location and distribution of these PLPs is automatically sent to the VIEWS software enabling secondary-side technicians to begin their investigation and identification. The point-click features allows them to automatically add and/or identify parts to be stored and tracked within FOTS during their investigations. (This is discussed in more detail below.)

FOTS stores either parts identified by secondary side personnel or PLP identified by ET examinations (either current or historical). Graphic or other electronic files associated with these parts are also stored. Actions that are required in the disposition of these parts or objects are also stored, as well as characteristics of each part or object (such as location, elevation, length, width, description, mass, etc.). Current and historical eddy current results information for active and bounding tube locations where parts/objects have been identified is also available from with FOTS. The determination of what is stored in FOTS is either visual (by secondary side personnel upon finding parts/objects during their search phases) or by analysis interpretation of data acquired from various probe techniques (which is automatically added into FOTS for tracking based on rules). Type and identity of parts/objects are specific to secondary side personnel based on their findings. A PLP entered into FOTS from ET results is based on signal interpretation analysis.

RAPTOR wraps VIEWS and FOTS together in a complimentary way, allowing for added and enhanced features as described herein such as the point-click automated addition of parts for tracking purposes as well as rule- and knowledge-based applications allowing for automation of action disposition.

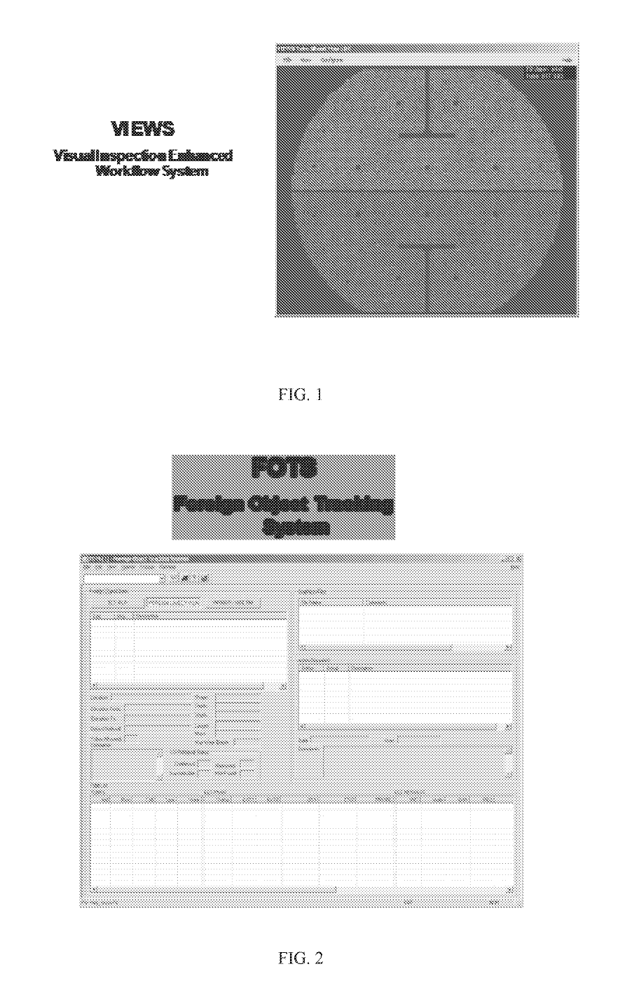

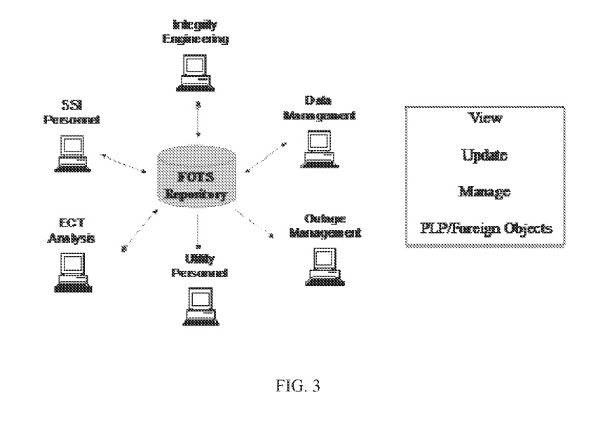

Another software algorithm evaluates the ET and visual results stored real time in FOTS for automated inspection planning and implementation of SG ET, better logistical planning of visual inspections, and provides user tools for engineering evaluation. This allows the user to point, click and add objects directly to the FOTS database upon identification. FIG. 2 shows a screen shot of a foreign object tracking system.

FIG. 3 shows a schematic view of the remote automated planning and tracking of recorded data system of the present invention, illustrating the central FOTS depository that interacts with a variety of other systems.

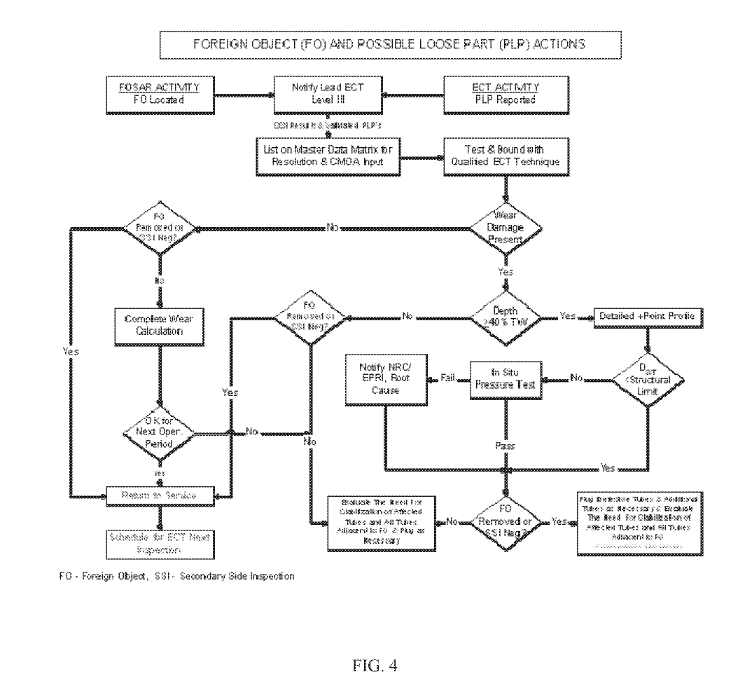

FIG. 4 shows a flowchart illustrating a general progression for the inventive foreign object identification action and disposition process. The process begins with the foreign object search and retrieval and current inspection testing routines to identify foreign objects (“FOs”) and possible loose parts. These potential hazards are entered into the RAPTOR system automatically in real-time as they are identified. Each foreign body is evaluated by RAPTOR using qualified techniques and rules, an example of which is illustrated in FIG. 4.

Initially, the location of the. FO is evaluated to determine if any wear damage is present. If such damage is present, it is qualified by comparison to a threshold level. In the example embodiment of FIG. 4, a depth greater than or equal to 40% the through-wall has been selected as the damage threshold level. If the wear damage meets the threshold, more detailed testing of the affected area(s) is performed. Such detailed testing can include detailed profiling with +PT™ probe and/or and in situ pressure testing, and may result in the steam generator tube(s) being plugged to prevent any potential fluid communication between the primary and secondary sides of the steam generator. It may be necessary to plug additional tubes in the zone surrounding the tube under evaluation. Additional analysis is performed to determine whether any of the tubes should be stabilized to provide additional structural support for the affected. tube(s).

An attempt to remove the FO object is made regardless of whether the wear damage exceeds the threshold level. If the FO is removed and the wear damage, if any, is below the threshold level, the steam generator can be returned to service. If the FO is not removed, additional testing and/or analysis is performed to determine whether any of the tubes should be stabilized to provide additional structural support for the affected tube(s). This may include calculating the potential wear damage that occur during a subsequent operational period for the steam generator under evaluation.

Information regarding known or historic foreign objects is available within the tracking system repository. Once a foreign object is identified, information on this object can be transmitted to the foreign object database. This action will be initiated by a user action, such as the user moving a pointing device such as a mouse pointer over an image of this object on a computer display and clicking a mouse button. The user can identify objects by using a camera to inspect various areas of the tube bundle. These identified objects can be added to the FOTS database by using a point-click method. By pointing the cursor over the picture of the object and clicking on a mouse button, a dialog is presented to the operator with an option to add this image to the FOTS database. Upon selection of this function, the operator is presented with a dialog to enter the object's pertinent characteristics such as location and elevation, affected tubes, dimensions, etc. Upon completing the dialog, the operator selects to “save” the information, which then is automatically written to the database and is retrievable by all parties involved in continuing the disposition process. After the part is entered into FOTS through these methods, the operator may add information to the part from within the VIEWS application by uploading and storing any further graphic files as necessary.

Turning again to FIG. 4, the process begins with the e identification of a Foreign Object (“FO”) by secondary-side personnel during SSI activities. These activities are either performed prior to eddy current testing or during eddy current testing as result of eddy current testing results. During secondary side inspection activities, operators use a camera to inspect specific areas of the tube bundle from the secondary side. Any object identified during the course of this inspection is identified and stored within the FOTS database either directly or through the VIEWS system. This may be carried out by either A) manually entering the foreign object characteristics along with pictures and tube location(s), or B) using a point-click method available in the VIEWS interface that allows the user to automatically enter the object information directly into FOTS with all pertinent characteristics.

A PLP is identified by eddy current analysis personnel during the course of eddy current probe testing of steam generator tubes. Utilizing signal interpretation methods, analysis personnel identify a PLP signal and make an electronic entry to a report file. Once this report file is uploaded to the eddy current data management system (“FDMS”), user-defined rules are triggered by FOTS to determine if any PLPs exist in the report. If a PLP does exist, the PLP information, now tracked by tube number, is automatically entered into FOTS.

Users may create strict procedural rules within FOTS, such as by using “if-then” conditional logic. Such rules may aid in either identifying which records from analysis are automatically added to FOTS based on eddy current results and/or action management for defining which actions to add based on values entered for affected and bounding tube eddy current results. As this implementation is procedural and cumbersome at times, the implementation from within RAPTOR is to provide a rule engine using forward chaining algorithms that will process the rules independent from FOTS as defined by the user. Rules may be defined by the user utilizing conditional logic based on values for the following types of properties:
ET indication code,
elevation,
existing actions within FOTS as well as their completion status,
analysis review status,
object confirmation by SSI,
detection method of an object,
accessibility by SSI to an object,
detection status of an object,
removal status of an object,
detection of wear on a tube relative to an object,
type of tube relative to a part (whether it is a bounding tube or an affected tube, and
other pertinent characteristics.

As used herein, “user-defined rules” applies to the definition of any combination of these properties by the user into a single rule that is stored with all the set of rules. The rule engine will process these rules as property values are updated based on an object being inserted, updated and/or deleted from the database.

An extension of the rule engine will be the trigger of a function to automatically plan for eddy current exam bounding tubes that have not already been planned. If a tube requires further eddy current examination utilizing a particular probe technique, and a rule defining this exists in the rule set, then once triggered, the function will interrogate the planning tables within FDMS for any eddy current exams. If plan for eddy current does not exist, the function will add the inspection requirements to the existing planning tables, and will alert the user within FOTS that a new plan has been added for a particular tube(s).

Utilizing either method A or B above, items (either objects or PLP locations) are now available to be tracked and dispositioned utilizing various methods available within FOTS, enhanced by tools available from RAPTOR, and finalized with action disposition, engineering evaluations, further eddy current testing and/or foreign object search and retrieval (“FOSAR”) activities. Items added into the FOTS repository utilizing methods A or B above serve as automatic notification to Analysis, Data Management, Secondary Side and Engineering personnel. The FOTS repository serves as the master Data Matrix as depicted in the example flowchart of FIG. 4.

A FO or PLP tube location is defined as an affected tube. Utilizing user-defined rules with FOTS, these tubes may be automatically bounded based on probe detection method. Automatic tube bounding may have also occurred when the affected tube was automatically entered into the FOTS repository, again based on probe detection method. Tubes identified as bounding tubes are matched with existing eddy current plans to determine if a plan exists or not for eddy current testing. If not, new functions applied from rules and dictionary definitions that are implemented with RAPTOR are applied against Furs and FDMS to automate further eddy current testing of pertinent tube locations.

As used herein, “actions” applies to a necessary step within the foreign object disposition process. For instance, an eddy current PLP is identified by analysis and added to FOTS for tracking. An action for this PLP that would be added either manually or through the automatic application of appropriate rule definitions might be: “SSI investigate location for PLP.” Another action might be: “Data Management Plan Bounding tubes of affected tubes with PLP Indications.” RAPTOR attempts to automate the determination and completion of these actions based on foreign object characteristics, SSI findings, and eddy current analysis results.

In the example flowchart, at this point, the remaining nodes and branches are completed through the application of action management. Actions required to continue the disposition process are applied and assigned within FOTS either manually or automatically through a rule inference application implemented with RAPTOR. These actions are completed as necessary by pertinent personnel and, based on the results of particular action(s), further actions may be applied to continue and or finalize the disposition process for a particular object or PLP. The intent of RAPTOR in this phase is to assist in the completion of the disposition process within the FOTS repository by automatically assigning actions based on the results and/or findings of previous actions and identified results, such as: wear present or not; wear depth exceeding defined thresholds (in the example flowchart, this would be 40%); further PLP indications called within bounding tubes; object removal status by SSI; in situ pressure test results; wear calculation; negative findings by SSI; etc. The disposition of an object or PLP completes when all actions have been completed by all appropriate personnel. Once an item in FOTS is finalized, planning functions implemented by RAPTOR may be initiated within FOTS for subsequent outage inspections.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments, but should be defined only in accordance with the following claims and their equivalents. Furthermore, while certain advantages of the invention have been described herein, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

What is claimed is:

1. A method of evaluating a piece of equipment, comprising:
a. performing a foreign object search of the equipment;
b. automatically populating a foreign objects database with objects found during said foreign object search;
c. evaluating a zone of the equipment in which a first of said objects was found;
d. determining based of said evaluating whether any damage caused by said first object meets a predetermined threshold amount;
e. if said damage meets or exceeds the threshold amount, performing a structural evaluation of said zone; and
f. determining whether said first object has been removed from the equipment.

2. The method of claim 1, further comprising repeating steps c-f for others of said found objects.

3. The method of claim 1, wherein said method is implemented via a non-transitory computer program product.

4. The method of claim 1, wherein said automatically populating includes:
providing an interface for a user to enter information about said first object; and
populating the foreign objects database based on said information.

5. The method of claim 4, wherein said providing is initiated by a user action.

6. The method of claim 5, wherein:
said method is implemented via a non-transitory computer program product; and
said user action is a computer-based action.

7. The method of claim 6, wherein said computer-based action includes:
displaying an image of said first object on a computer display;
positioning a pointing device atop said image; and
pressing a button.

8. The method of claim 1, wherein said performing said foreign object search includes performing an eddy current test of the equipment.

9. A method of evaluating a piece of equipment, comprising:
a. performing an eddy current test of the equipment;
b. automatically populating a database with objects found during said eddy current test;
c. evaluating a zone of the equipment in which a first of said objects was found;
d. determining based of said evaluating whether any damage caused by said first object meets a predetermined threshold amount;
e. if said damage meets or exceeds the threshold amount, performing a structural evaluation of said zone; and
f. determining whether said first object has been removed from the equipment.

10. The method of claim 9. further comprising repeating steps c-f for others of said found objects.

11. The method of claim 9, wherein said method is implemented via a non-transitory computer program product.

12. The method of claim 9, wherein said automatically populating includes:
providing an interface for a user to enter information about said first object; and
populating the foreign objects database based on said information.

13. The method of claim 12, wherein said comparing is initiated by a user action.

14. The method of claim 13, wherein:
said method is implemented via a non-transitory computer program product; and
said user action is a computer-based action.

15. The method of claim 14, wherein said computer-based action includes:
displaying an image of said first object on a computer display;
positioning a pointing device atop said image; and
pressing a button.

16. The method of claim 9, wherein said performing said foreign object search includes performing an eddy current test of the equipment.

17. The method of claim 9, wherein said performing said foreign object search includes performing an eddy current test of the equipment.
